(19) United States
(12) Patent Application Publication
(10) Pub. No.: US 2016/0295298 A1
(43) Pub. Date: Oct. 6, 2016

(54) CONGESTION MITIGATION METHOD AND APPARATUS CONSIDERING OPTIMIZATION OF USER SATISFACTION OF VIDEO TRAFFIC IN MOBILE NETWORK

(71) Applicant: SAMSUNG ELECTRONICS CO., LTD., Gyeonggi-do (KR)

(72) Inventors: Hyungho Lee, Seoul (KR); Jicheol Lee, Gyeonggi-do (KR); Hanna Lim, Seoul (KR)

(21) Appl. No.: 15/038,441

(22) PCT Filed: Nov. 20, 2014
(86) PCT No.: PCT/KR2014/011221

§ 371 Date: May 20, 2016

(30) Foreign Application Priority Data
Nov. 20, 2013 (KR) 10-2013-0141055

(51) Int. Cl. H04N 21/647; H04N 21/2381; H04L 29/08; H04W 4/06; H04L 29/06; H04L 12/66; H04N 21/2343; H04N 21/238; H04L 12/813

(52) U.S. Cl. CPC H04N 21/64792; H04N 21/23805; H04N 21/2381; H04N 21/64738; H04L 67/02; H04L 47/20; H04L 65/608; H04L 12/66; H04N 21/23439; H04W 4/06

(57) ABSTRACT

The present invention relates to a method and an apparatus for providing a congestion mitigation method in a mobile communication network. A communication method of Packet data network-Gateway (P-GW) in a mobile communication system according to an embodiment of the present invention may comprise the steps of: identifying video information by using a video request message of a terminal and a video response message of a content server; receiving a video packet from the content server; identifying the buffer status of the terminal by using the video packet; recording, in the header of the video packet, video traffic information comprising the video information and the buffer status information of the terminal; and transmitting the video packet having the video traffic information recorded therein to a base station. According to an embodiment of the present invention, when congested, Quality of Experience (QoE) can be maximized under a restricted environment (resources).

### TECHNICAL FIELD

The present invention relates to a method and apparatus for mitigating congestion in a mobile communication network. More specifically, this invention relates to a method and apparatus for providing congestion mitigation, considering characteristics of a video, in a mobile communication network, when application layer information regarding video traffic is transmitted to components of the mobile communication network, using the headers of mobile network packets, and the components perform Per-Hop-Behavior (PHB) or congestion mitigation related to user plane congestion control (UPCON) as a 3GPP study theme in a congestion state.

### BACKGROUND ART

A mobile communication network, e.g., Evolved Packet Core (EPC) network, is capable of distinguishing between bearers by Quality of Service (QoS) Class Identifier, shortened to QCI. QCI distinguishes between bearers based on nine types of classes, such as IP Multimedia Subsystem (IMS) signaling, voice, video, etc.; however, it does not distinguish bearers in terms of video traffic.

Since most traffic uses only one default bearer as a value assigned to a bearer, QCI has the same value. Therefore, QCI cannot distinguish between bearers using property of video traffic.

In mobile communication networks, entities of individual EPC networks use Differentiated Services (DiffServ), Explicit Congestion Notification (ECN), and packet drop (e.g., Random Early Drop (RED), as a congestion mitigating method. Mobile communication networks are researched by various themes, e.g., 3GPP User plane congestion control (UPCON), etc.

For example, functions related to congestion of evolved Node B (eNB) are described in 3GPP TS23.401, etc., titled “Transport level packet marking in the uplink, e.g. setting the DiffServ code Point, based on the QCI of the associated Evolved Packet System (EPS) bearer,” “ECN-based congestion control,” etc. In addition, functions related to congestion of Serving-Gateway (S-GW) and Packet data network-Gateway (P-GW) are described in 3GPP TS23.401, etc., titled “Transport level packet marking in the uplink and the downlink, e.g. setting the DiffServ Code Point, based on the QCI of the associated EPS bearer,” etc. Its detailed description is omitted in this disclosure.

For video traffic transmission, there are a Progressive Download (PDL) scheme and an HTTP Adaptive Streaming (HAS) scheme.

The PDL refers to a method that allows users to download and play back a video file from a location, referring to information required to play back media is stored in the header of a media file or in every frame. The PDL typically uses the HTTP protocol.

The HAS refers to a method that splits video into small fragments (e.g., a unit of a few seconds), stores the fragments, and transmits them in order. The small fragment is called a chunk. In general, a chunk is formed with video files encoded at three or four bit rates. Information regarding chunks (e.g., bitrate, size, duration, URL, etc.) is formed with a metafile created by XML of a form of time interval matrix. Therefore, the HAS allows the video player to: check the experienced bandwidth condition and CPU use, referring to a metafile containing information regarding the video file; select chucks of the corresponding quality; request the chunks; and receives them.

### DISCLOSURE OF INVENTION

### Technical Problem

However, the congestion mitigation for a conventional Evolved Packet Core (EPC) network has not considered the following matters. The conventional congestion mitigation has not considered differences between video application transmissions according to types of video traffic transmission, such as Progressive Download (PDL), HTTP Adaptive Streaming (HAS), Media adaptation, etc.

The conventional congestion mitigation has not considered that the effect of Quality of Experience (QoE) with respect to the same congestion condition varies according to types of video application transmission. For example, PDL does not have a function for adjusting the bit rate of video traffic according to available bandwidths (BWs). Therefore, PDL experiences a re-buffering created when congestion occurs. In contrast, HAS is capable of adjusting the bit rate of video traffic according to available bandwidths (BWs). Therefore, HAS is capable of reducing the video quality when congestion occurs, so that re-buffering does not occur.

Although the video application transmission is used for the same congestion condition, the level of reduction in QoE may vary. For example, in a state where the video application transmission employs HAS, when the video traffic is adjusted from a relatively high bitrate to a medium bitrate, the level of reduction in QoE may be relatively small. In contrast, in a state where the video application transmission employs HAS, when the video traffic is adjusted from a medium bitrate to a low bitrate, the level of reduction in QoE may be relatively large. This is because, when the bitrate increases, the amount of increase in QoE does not increase linearly according to the bit rate.

The present invention has been made to address the above problems and disadvantages, and to provide a communication method of a mobile communication system.

An embodiment of the present invention provides an objective to maximize QoE in an environment where congestion occurs, considering characteristics of a video characteristics and the QoE factor, for: Differentiated Services (DiffServ) of Serving-Gateway (S-GW), Packet data network-Gateway (P-GW) of EPC; packet drop (e.g., Random Early Detection (RED)) of Explicit Congestion Notification (ECN) of evolved Node B (eNB); and ECN marking.

This section, technical problem, is merely intended to provide a few aspects of the present invention. It should be understood that the features and advantages of the present invention are not limited to those in the foregoing description, and the other features and advantages not described above will become more apparent from the following description.

### Solution to Problem

In accordance with an aspect of the present invention, a communication method of a Packet data network-Gateway (P-GW) in a mobile communication system is provided. The method includes: identifying video information, using a video request message of a terminal (user equipment, or UE) and a video response message of a content server; receiving a video packet from the content server; detecting a buffer status of the terminal, using the video packet; recording, in a header of the video packet, Video Traffic Information for Congestion control (VTIC) containing information regarding the buffer status of the terminal and the video information; and transmitting the video packet in which the VTIC is recorded to a base station (eNB).

Preferably, identifying video information includes: requesting user policy information from a Policy and Charging Rules Function (PCRF); and receiving user policy information from the PCRF.

Preferably, identifying video information includes: receiving an HTTP request message from the terminal; identifying a video request message using the HTTP request message; receiving an HTTP response message from the content server; and identifying video content information using the HTTP response message.

Preferably, identifying video information includes: receiving a metadata file request message from the terminal; identifying a video request message, using the metadata file request message; receiving a metadata file from the content server; and identifying video content information, using the metadata file.

Preferably, the VTIC includes at least one of the following: user rating information, service provider information, a video transmission type, a buffer status of the terminal, a Quality of Experience (QoE) efficiency level, and an adaptation method.

Preferably, when the video transmission type is an HTTP Adaptive Streaming (HAS) scheme, the QoE efficiency level is calculated, using a transmission rate of video currently transmitted in HAS, a transmission rate of video lower in quality by one level than that currently transmitted in HAS, and QoE information according to the transmission rate.

In accordance with another aspect of the present invention, a communication method of a base station (eNB) in a mobile communication system is provided. The method includes: receiving a video packet in which Video Traffic Information for Congestion control (VTIC) is recorded from a P-GW; determining whether to apply congestion mitigation of video traffic to the received video packet, using the VTIC; and adjusting a transmission rate of the video packet, and transmitting the video packet to a terminal at the adjusted transmission rate. The VTIC contains information regarding a buffer status of the terminal and video information that the P-GW has identified using a video request message of the terminal and a video response message of a content server.

Preferably, transmitting the video packet to a terminal includes: transmitting, to the P-GW, a transmission rate adjustment request message for a video packet to which congestion mitigation is applied; receiving a video packet whose transmission rate is adjusted from the P-GW; and transmitting, to the terminal, the video packet whose transmission rate is adjusted.

In accordance with another aspect of the present invention, a Packet data network-Gateway (P-GW) of a mobile communication system is provided. The P-GW includes: a communication unit for communicating with other network entities; and a controller for: identifying video information, using a video request message of a terminal (user equipment, or UE) and a video response message of a content server; receiving a video packet from the content server; detecting a buffer status of the terminal, using the video packet; recording, in a header of the video packet, Video Traffic Information for Congestion control (VTIC) containing information regarding the buffer status of the terminal and the video information; and transmitting the video packet in which the VTIC is recorded to a base station (eNB).

In accordance with another aspect of the present invention, a base station (eNB) of a mobile communication system is provided. The base station includes: a communication unit for communicating with other network entities; and a controller for; receiving a video packet in which Video Traffic Information for Congestion control (VTIC) is recorded from a P-GW; determining whether to apply congestion mitigation of video traffic to the received video packet, using the VTIC; adjusting a transmission rate of the video packet; and transmitting the video packet to a terminal at the adjusted transmission rate. The VTIC contains information regarding a buffer status of the terminal and video information that the P-GW has identified using a video request message of the terminal and a video response message of a content server.

### Advantageous Effects of Invention

The mobile communication system according to an embodiment of the present disclosure is capable of maximizing Quality of Experience (QoE) in a limited environment (resources) when congestion occurs.

When a breaking phenomenon may have the highest priority, the mobile communication system is capable of reducing a re-buffering, via an ECN packet marking/dropping method, considering types of video playback.

When a breaking phenomenon is prevented and only HAS is used, the mobile communication system is capable of maximizing QoE using the relationship between the transmission rate and the QoE.

It should be understood that the advantageous effects of the present invention are not limited to those in the foregoing description, and the other effects not described above will become more apparent from the following description.

### BRIEF DESCRIPTION OF DRAWINGS

FIG. 1 is a diagram showing a mobile communication system according to an embodiment of the present invention.

FIG. 2 is a flowchart that describes operations of mobile communication system according to an embodiment of the present invention.

FIG. 3 is a probability graph when packet drop is employed for short description according to an embodiment of the present invention.

FIG. 4 is a block diagram of a P-GW according to an embodiment of the present invention.

FIG. 5 is a block diagram of an eNB according to an embodiment of the present invention.

### MODE FOR THE INVENTION

Embodiments of the present invention are described in detail referring to the accompanying drawings.

In the description of the invention, certain detailed explanations of related art are omitted when it is deemed that they may unnecessarily obscure the essence of the invention.

Detailed descriptions of well-known functions and structures incorporated herein may be omitted to avoid obscuring the subject matter of the invention. The terms or words described in the description and the claims should not be limited by a general or lexical meaning, instead should be analyzed as a meaning and a concept through which the inventor defines and describes the invention to the best of his/her ability, to comply with the idea of the invention.

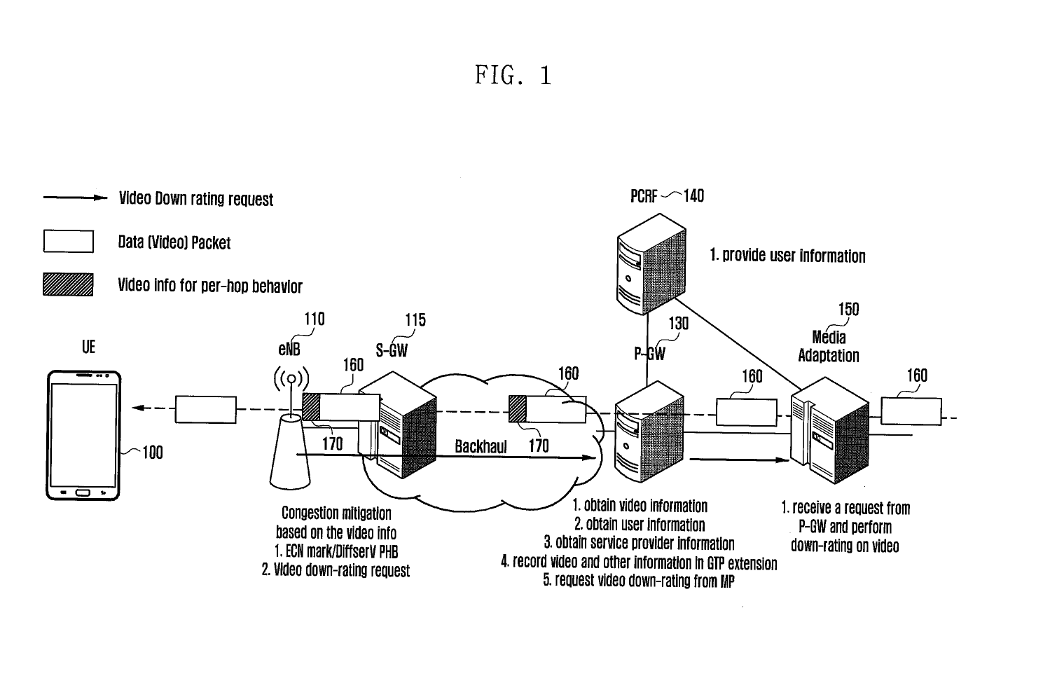

FIG. 1 is a diagram showing a mobile communication system according to an embodiment of the present invention.

Referring to FIG. 1, the mobile communication system is capable of including User Equipment (UE) (terminal) 100 and eNB: evolved Node B (eNB) 110, Serving-Gateway (S-GW) 115 and Packet data network-Gateway (P-GW) 130, which communicate with the UE 100. Although it is not shown, the mobile communication system is capable of further including a content server for providing content to the UE 100 according to the request. In another embodiment, the mobile communication system is capable of further including a Policy and Charging Rules Function (PCRF) 140 for determining Quality of Service (QoS) and charging policy, distinguished according to service flow. In another embodiment, the mobile communication system is capable of further including a Media Adaptation Function (MAF) 150 for selecting video traffic which needs to reduce the transmission rate according to the request of the P-GW 130 and down-rating the selected video traffic.

As shown in FIG. 1, the video traffic packet 160 transmitted in an Evolved Packet Core (EPC) network may include a header 170 containing the characteristics of the video traffic. A detailed description will be provided later.

Operations of the P-GW 130 are described below referring to FIG. 1. The P-GW 130 is capable of tracing an HTTP request message of a user (i.e., UE 100) and an HTTP response message of a content provider (e.g., the content server described above), thereby obtaining video information. In another embodiment, the P-GW 130 is capable of tracing a video metadata file request message of the UE 100 and a response message of the content provider and thus obtaining HTTP Adaptive Streaming (HAS) video information. The P-GW 130 is capable of observing a transmission status of the video packet 160 and predicting a video play-out buffer status of a video player of the UE 100.

In another embodiment, the P-GW 130 may be connected to a policy server, e.g., the PCRF 140, and obtain information regarding a user policy and a charging policy.

The P-GW 130 is capable of calculating information serving as a basis for determining a congestion mitigation operation of other EPC entities, using the video information, information regarding a play-out buffer of a video player of the UE 100, etc. For example, the P-GW 130 is capable of calculating the QoE efficiency information per bit or the QoE efficiency level information per bit. A detailed description will be provided later.

After that, the P-GW 130 is capable of recording the video traffic information in the header 170 of the video packet 160. That is, as shown in FIG. 1, the P-GW 130 is capable of recording Video Traffic Information for Congestion control (VTIC), containing the user policy information, the information regarding a buffer state of the UE 100 obtained as described above, and/or the video information obtained from the content provider, in the header 170 of the video packet 160 provided from the content provider. The P-GW 130 is capable of transmitting the video packet 160 containing the VTIC to the UE 100, the eNB 110 or the S-GW 115. A detailed description regarding the VTIC will be provided later.

Although it is not shown, in another embodiment, recording the VTIC in the header 170 of the video packet 160 may be performed by a separate entity instead of the P-GW 130.

Referring to FIG. 1, operations of the S-GW 115 or eNB 110 are described below. The following operations may be performed in the eNB 110 or S-GW 115. Alternatively, part of the following operations may be performed in the eNB 110 and another part may be performed in the S-GW 115. In the following description, for the sake of convenience, the S-GW 115, the eNB 110, etc. may be called a user plane entity. Although the embodiment is described in such a way that the user plane entity is the eNB 110 and the S-GW 115, it should be understood that the present invention is not limited thereto. The following description is, for the sake of convenience, explained in such a way that operations are performed in the eNB 110.

The eNB 110 is capable of performing congestion mitigation, using VTIC 170 that the P-GW 130 adds to the video packet 160.

The eNB 110 is capable of determining whether it performs congestion mitigation on the video traffic received according to congestion states of each entity, using the VTIC 170 provided from the P-GW 130.

For example, the eNB 110 is capable of selecting a video packet to employ Per-Hop-Behavior (PHB) of Differentiated Services (DiffServ). Alternatively, the eNB 110 is capable of selecting a video traffic packet to employ Explicit Congestion Notification (ECN) packet marking. The eNB 110 is capable of reducing a transmission rate for the selected video traffic packet. Alternatively, the eNB 110 is capable of selecting session or video traffic to transmit a congestion notification to other entity in the EPC, and may transmit the congestion notification message to the entity. A detailed description will be provided later.

In another embodiment, the P-GW 130 is capable of receiving the congestion notification message from the eNB 100, and performing the transcoding, transrating, and pacing processes. That is, the P-GW 130 is capable of reducing a transmission rate of the video traffic packet selected for congestion mitigation. In another embodiment, reducing a transmission rate of the video traffic packet may be performed by a separate entity instead of the P-GW 130. The separate entity may be a Media Adaptation Function (MAF) 150, TDF, Application Function (AF), etc. which are capable of performing media adaptation.

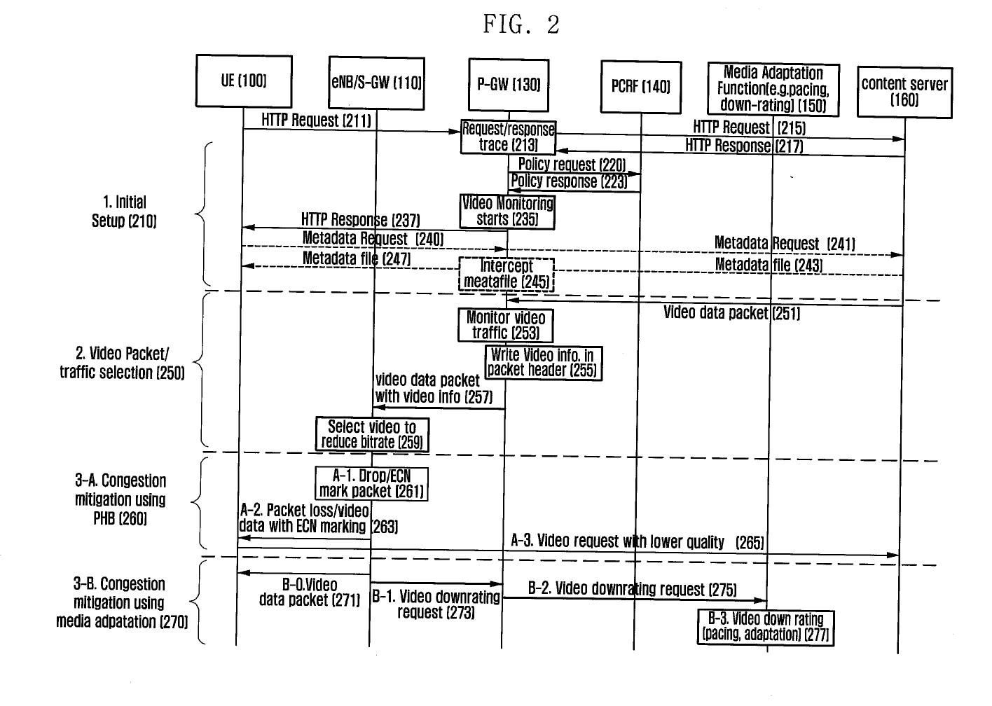

FIG. 2 is a flowchart that describes operations of a mobile communication system according to an embodiment of the present invention.

Referring to FIG. 2, the mobile communication system performs the initial setup in operation 210. The mobile communication system writes VTIC in the header of every video packet and allows other entities to select a transmission rate of traffic when congestion occurs in operation 250. After that, the mobile communication system performs congestion mitigation in operations 260 and 270. The operations are described in detail below.

The initial setup as in operation 210 is described in detail below.

The UE 100 is capable of transmitting an HTTP request message to a Content Server (CS) 160 in operation 211. The P-GW 130 intercepts the HTTP request message in transmission from the UE 100 to the CS 160 and ascertains that the HTTP request message is a message requesting video content in operation 213. After that, the P-GW 130 is capable of transmitting the HTTP request message of the UE 100 to the CS 160 in operation 215.

The CS 160 is capable of transmitting an HTTP response message to the UE 100, in response to the HTTP request message of the UE 100, in operation 217. In this case, the P-GW 130 is capable of intercepting the HTTP response message of the CS 160 in transmission, and ascertaining information regarding the video content. After that, the P-GW 130 is capable of transmitting the HTTP response message of the CS 160 to the UE 100 in operation 237. The P-GW 130 is capable of staring to monitor the video in operation 235.

In another embodiment, the P-GW 130 identifies video traffic via the HTTP request message of UE 100 and the HTTP response message of the CS 160 and requests user policy, charging policy, etc. from a policy server, such as PCRF 140 in operation 220. After that, the P-GW 130 is capable of receiving a corresponding user policy, charging policy, etc. from the PCRF 140 in response to the request in operation 223. The information that the P-GW 130 obtained from the PCRF 140 may contain user ranking information, such as a condition as to whether a corresponding user is a premium user, etc. After obtaining the user policy information, the P-GW 130 is capable of starting video traffic.

In another embodiment, when video traffic transmission is HTTP Adaptive Streaming (HAS), the UE 100 is capable of transmitting a metadata request message to the CS 160 in operation 240. Like the HTTP request message, the P-GW 130 is capable of intercepting the metadata request message in transmission, and ascertaining that the metadata request message of the UE 100 is a message requesting video content. After that, the P-GW 130 is capable of transmitting the metadata request message of the UE 100 to the CS 160 in operation 241.

The CS 160 is capable of transmitting the metadata file to the UE 100, in response to the metadata request message of the UE 100 in operation 243. In this case, the P-GW 130 is capable of intercepting the metadata file in transmission and identifying information regarding video traffic within the HAS metadata file in operation 245.

The video packet/traffic selection as in operation 250 is described in detail below.

Although it is not shown, the UE 100 is capable of transmitting, to the CS 160, a video data request message requesting video data. The CS 160 is capable of transmitting a video data packet to the P-GW 130 in response to the request in operation 251. In this case, the P-GW 130 is capable of monitoring video traffic in operation 253. That is, the P-GW 130 is capable of continuously monitoring the received video packet and detecting an amount of transmitted video data. The P-GW 130 is capable of detecting how much video data a play-out buffer of a video player of UE 100 is filled with, based on the detected information.

After that, the P-GW 130 is capable of writing video traffic information in the header of a packet in operation 255. More specifically, after receiving the video packet in operation 251, the P-GW 130 is capable of writing Video Traffic Information for Congestion control (VTIC) in the header of a video packet, based on the user policy information and/or the video information obtained via the initial setup of operation 210 and the video information by tracing every packet in operation 253. The detailed description regarding the VTIC will be provided later. The header of a video packet may be an option field of an IP header, a GTP extension header, etc.

After containing the VTIC in the video packet in operation 255, the P-GW 130 is capable of transmitting the video packet where the VTIC is written to an EPC user plane entity 110 in operation 257. As described above, the user plane entity 110 may include an S-GW and an eNB.

After receiving the VTIC, the user plane entity 110 is capable of determining whether it applies congestion mitigation to the received video traffic, according to the level of congestion of each entity and the received VTIC in operation 259. That is, the user plane entity 110 is capable of determining whether it reduces a transmission rate of the received video traffic in operation 259. A detailed description regarding a method of selecting video with applying congestion mitigation will be provided later.

Congestion mitigation of operations 260 and 270 is described in detail below. Congestion mitigation is performed in such a way that: the user plane entity 110 of the S-GW or eNB determines that congestion mitigation is required in operations 210 and 250; and reduces a transmission rate of corresponding video traffic based on the determination.

Congestion mitigation may performed by a Per-Hop-Behavior scheme independently performed by each entity, a core media adaption scheme, and a local media adaption scheme. Congestion mitigation may be performed in such a way that one of the three schemes is independently used. Alternatively, congestion mitigation may be performed in such a way that two or more of the three schemes are used. It should be understood that the congestion mitigation described above is an example. It should be understood that the present invention may also employ another scheme to reduce a transmission rate of video traffic for congestion mitigation.

Congestion mitigation independently performed by each entity as in operation 260 is described in detail below. The user plane entity 110 is capable of performing congestion mitigation in operation 261.

More specifically, each entity of the user plane entity 110 independently performs congestion mitigation using Per-Hop-Behavior (PHB). Congestion mitigation may be performed by a PHB congestion control method of DiffServ, a method of marking ECN in an IP header via ECN, a method of dropping packets via a Random Early Drop (RED) scheme as one of the active queue management schemes, etc. The RED scheme is useful when the transmission of video traffic employs the HAS scheme. The user plane entity 110 is capable of transmitting packet loss/video data to the UE 100 in operation 263.

When the processes described above are performed, a transmission rate of a TCP sender is reduced according to a congestion control process of TCP of the UE 100. Therefore, the UE 100 requests a video with a low transmission rate, i.e., a low quality video, in operation 265.

Congestion mitigation performed using a core media adaption is described in detail below. In order to perform the congestion mitigation, it is assumed that the P-GW 130 includes a Core Media Processor (CMP) with a function for down-rating video traffic. The video traffic down-rating function may include a media adaptation function, e.g., pacing, transcoding, transrating, etc. Alternatively, a separate application function with the video traffic down-rating function may be applied to a network environment connected to the P-GW 130. An embodiment of FIG. 2 uses a Media Adaptation Function (MAF) 150 as the application function; however, it should be understood that the application function may be called different names.

After selecting video traffic that needs to be reduced in a transmission rate, the user plane entity 110 is capable of transmitting a video down-rating request message to the P-GW 130 or the CMP 150 in operation 273. When the P-GW 130 receives the video down-rating request message, it is capable of transmitting the video down-rating request message to the CMP 150 in operation 275.

The P-GW 130 or CMP 150 performs down-rating on the video traffic received from the CS 160 and transmits the down-rated video traffic to the UE 100 or the user plane entity 110 in operation 277.

Congestion mitigation using a local media adaption is described in detail below. In order to perform the congestion mitigation, it is assumed that the user plane entity 110, such as eNB, S-GW, etc., includes a Local Media Processor (LMP) with a function for down-rating video traffic. The video traffic down-rating function may include a media adaptation function, e.g., pacing, transcoding, transrating, etc. Alternatively, a separate application function with the video traffic down-rating function may be applied to a network environment connected to an S-GW or an eNB.

When the user plane entity 110 selects video traffic that needs to be reduced in a transmission rate, the LMP performs down-rating on the video traffic received from the CS 160 and transmits the down-rated video traffic to the UE 100.

Although the embodiment is described in such a way that the P-GW 130 obtains VTIC and writes the VTIC in the header of a video packet, it should be understood that the embodiment may further include a separate network entity in addition to the P-GW 130. In this case, the separate network entity may perform part or all of the functions of the P-GW 130. Alternatively, the embodiment may be modified in such a way as to further include a separate network entity in addition to the user plane entity 110. In this case, the separate network entity may perform part or all of the functions of the user plane entity 110.

The foregoing description has explained processes of: writing VTIC in the header of a video packet; determining whether it applies congestion mitigation thereto; and reducing a transmission rate of video traffic in a mobile communication system according to an embodiment of the present invention.

In the following description, the VTIC is described in detail.

VTIC may contain at least one item of information in the following table 1.

TABLE 1

| Items | Description | Values |
|---|---|---|
| Subscriber Info | User ratings | User ratings: GOLD, SILVER, BRONZE |
| Service Provider | Main body providing video | Mobile network operator (Telco), Provider contacting with |
| Info | service | operator, etc. |
| Video Type | Video transmission type | PDL or HAS |
| Video play-out | Playback of UE, detected | re-buffering: a recovering process from stop/pause, |
| buffer status | by tracing video | mid: a viewing process, |
| | transmission | initial buffering: the initial process |
| QoE efficiency | Level of effect to QoE, | Long description: |
| level | when transmission rate of | For PDL and HAS(LQ): play-out buffer status (sec) |
| | video traffic is reduced | For HAS (MQ, HQ): QoE increment per bit (refer to the |
| | | following explanation) |
| | | Short description: |
| | | P-GW distinguishes between the above described |
| | | estimation items based on a standard and allocates them |
| | | RED(=0) > YELLOW(=1) > GREEN (2) |
| Adaptation | Media adaptation function | Message to CMP (=0): use of Rate Limiting, Pacing, |
| method | supported by a network | Media Adaptation PHB: use of Packet Drop or ECN |
| | | marking LMP |

More specifically, ‘Subscriber Info’ refers to user ratings. For example, the ‘Subscriber Info’ may be obtained, using the user policy and charging policy information that the P-GW 130 received from the PCRF 140 in operations 220 to 223 in FIG. 2. In an embodiment, the user policy may contain information regarding a user rating. For example, a user rating may be classified into three, such as GOLD, SILVER, and BRONZE, described in table 1, but is not limited thereto. It should be understood that a user rating may be classified into two, four or more ratings.

‘Service Provider Info’ refers to information regarding a main body who provides a video service. For example, ‘Service Provider Info’ may be information regarding one of the following: a mobile network operator (Telco) from which UE currently uses services, another service provider which contacts with the mobile network operator, and other service providers except for the operator and the contractor described above.

‘Video Type’ refers to a video transmission type of a video packet. For example, ‘Video Type’ may be information indicating a PDL scheme or HAS scheme.

‘Video play-out buffer status’ refers to information regarding a playback of UE, detected by tracing video transmission. A current video playback status of UE may be one of the following: re-buffering process, mid process, and initial buffering process. The re-buffering process refers to a process of recovering playback from stop/pause. The mid process refers to a process where video data is under playback on the UE. The initial buffering process refers to a process where video data starts to be played back.

‘QoE efficiency level’ refers to information regarding a level of effect on QoE when a transmission rate of current video traffic is reduced. The QoE efficiency level may be represented via a long description and/or short description.

When a QoE efficiency level has a long description, it may contain play-out buffer status information for an HAS scheme of low quality (LQ) or PDL scheme. In this case, the unit of play-out buffer status information may be second. In addition, the QoE efficiency level may contain QoE increment per bit for an HAS scheme of medium quality (MQ) or high quality (HQ).

The QoE increment per bit may be obtained by the following Equation 1.

$$\frac{{QoE}_{current} - {QoE}_{next}}{{BR}_{current} - {BR}_{next}} \qquad [ Equation 1 ]$$

In Equation 1, BR_{current} denotes a transmission rate of video currently transmitted in HAS and BRₙₑₓₜ denotes a transmission rate of video lower in quality by one level than that currently transmitted in HAS. QoE_{current} denotes a degree of user satisfaction of the video currently transmitted in HAS and QoEₙₑₓₜ denotes a degree of satisfaction lower in quality by one level than that currently transmitted in HAS.

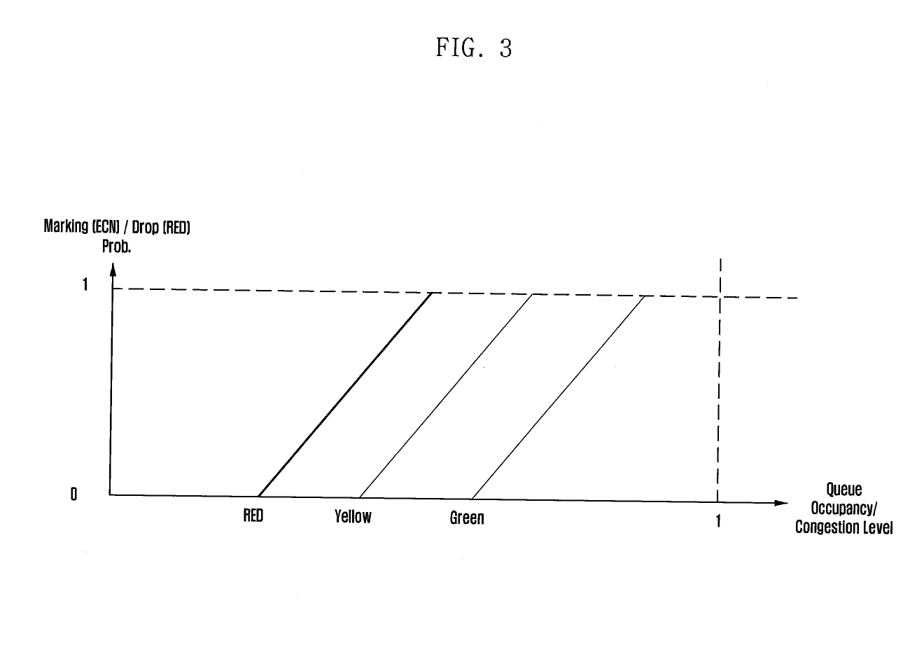

FIG. 3 is a probability graph when packet drop is employed for short description according to an embodiment of the present invention.

Referring to FIG. 3, when a QoE efficiency level has a short description, the P-GW distinguishes between the estimation items described above, based on a standard, and allocates them. For example, the P-GW may distinguish the ECN marking or packet drop probability into three areas, red, yellow, and green, according to the queue occupancy or congestion level. In another embodiment, it should be understood that the P-GW may distinguish the ECN marking or packet drop probability into two or four or more areas. When corresponding video traffic is in a red area, the transmission rate is reduced relatively rapidly. When corresponding video traffic is in a green area, the transmission rate is reduced relatively slowly.

In another embodiment, the VTIC may further contain information regarding an adaptation method. The information regarding an adaptation method is an item of a media adaptation function supported by a corresponding mobile communication network. For example, the information regarding an adaptation method may contain information regarding a condition as to whether a corresponding network uses CMP or LMP. In addition, the information regarding an adaptation method may contain information regarding a condition as to whether a network uses PHB. That is, the information regarding an adaptation method may contain information regarding a condition as to whether a network uses packet drop or ECN marking.

In the foregoing description, VTIC has been explained.

The following description provides a method of selecting a video whose transmission rate needs to be reduced when congestion mitigation is performed.

As described above, when the user plane entity 110 ascertains that congestion mitigation needs to be performed, based on the VTIC described above, it may select a video whose transmission rate needs to be reduced.

In this case, the user plane entity 110, such as an eNB or an S-GW, is capable of selecting a video traffic whose transmission rate needs to be adjusted, based on the information described in table 1.

For example, the user plane entity 110 is capable of determining subscriber priority, based on subscriber information. In this case, when a subscriber has a relatively high rating, the user plane entity 110 sets the subscriber to have high priority and selects a video traffic of a low priority, thereby adjusting the transmission rate. For example, when a user has subscriber priority, e.g., GOLD>SILVER>BRONZE, the video traffic with subscriber information of BRONZE may be set so that its transmission rate can be reduced.

In addition, the user plane entity 110 is capable of determining service provider priority, based on service provider information. In this case, service provider priority may be prioritized from the highest to the lowest in order of: a mobile network operator (Telco) currently used by UE, the next user (Contract) contracting a mobile network operator, and other service providers (Others) except of the operator and the contractor, i.e., Telco>Contract>Others. A video traffic of the lowest priority may be selected so that its transmission rate can be reduced.

In addition, the user plane entity 110 is capable of determining Video Type priority, based on video type information. When transmission of Video Type is stopped and thus the service quality is greatly degraded, the service is set to have high video type priority and thus this type of service is first served. For example, when a transmission rate of video traffic in PDL is reduced, the transmission efficiency of video traffic is greatly decreased. In this case, the QoE may be relatively greatly degraded, compared with the reduction of a transmission rate in HAS. Therefore, as the priority of PDL is determined to be higher than that of HAS, video traffic of an HAS transmission type may be selected to reduce its transmission rate first.

In addition, the user plane entity 110 is capable of determining video play-out buffer status priority, based on video play-out buffer status information. In this case, the priority is determined in order of: re-buffering process>mid process>initial buffering process. That is, in a state where playback of video data is stopped/paused, playback may be resumed from stop. In this case, transmission of video packet may be delayed. This may degrade QoE to be worse than the remaining two cases. Therefore, the video traffic in a process of starting playing back video data may be selected to reduce the transmission rate.

In addition, the user plane entity 110 is capable of determining QoE efficiency level priority, based on a QoE efficiency level. For example, for the same video type, the priority may be determined based on the QoE efficiency level. That is, when the QoE efficiency level is low, or a transmission rate of video traffic is reduced, video traffic which has a less effect on QoE may be selected to have low priority.

When a long description is used, the user plane entity 110 may calculate a QoE increment per radio resource block using the following equation 2. The traffic of the minimum QoE increment is set to have the lowest priority.

$$\frac{{QoE}_{current} - {QoE}_{next}}{{BR}_{current} - {BR}_{next}} \times MCS . \qquad [ Equation 2 ]$$

In Equation 2, BR_{current} denotes a transmission rate of video currently transmitted in HAS and BRₙₑₓₜ denotes a transmission rate of video lower in quality by one level than that currently transmitted in HAS. QoE_{current} denotes a degree of user satisfaction of video currently transmitted in HAS and QoEₙₑₓₜ denotes a degree of satisfaction lower in quality by one level than that currently transmitted in HAS. MCS stands for Modulation Coding Scheme.

The user plane entity 110 is capable of selecting a video traffic whose transmission rate needs to be reduced, using the information regarding the order of priority described above. In this case, video traffic may be selected using one of the priorities. Alternatively, video traffic may be selected by a combination of two or more of the priorities.

The foregoing description has explained a method of selecting a video whose transmission rate needs to be reduced, when congestion mitigation is performed.

In the following description, configurations of user plane entity and a P-GW are described in detail.

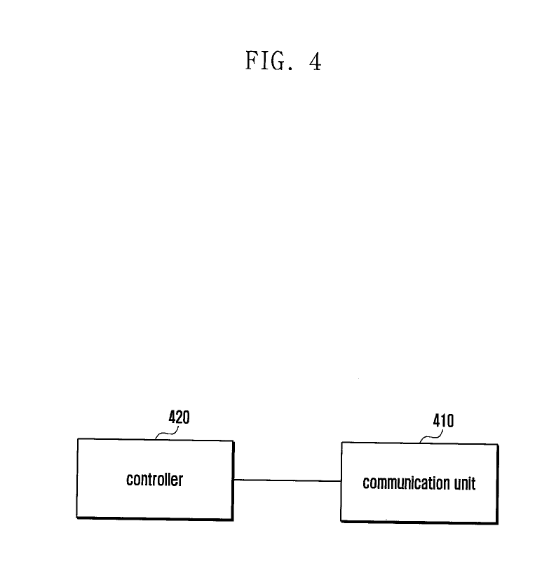

FIG. 4 is a block diagram of a P-GW according to an embodiment of the present invention.

Referring to FIG. 4, the controller 420 controls a P-GW to perform operations of one of the embodiments described above. For example, the controller 420: identifies video information using a video request message of UE and a video response message of a content server; receives a video packet from the content server; detects a buffer status of the UE, using the video packet; records VTIC, containing the video information and the buffer status of the UE, in the header of the video packet; and transmits the video packet in which VTIC is recorded to an eNB.

The communication unit 410 performs transmission/reception of signals according to operations of one of the embodiments described above. For example, the communication unit 410 transmits/receives data to/from: a communication unit of UE and/or a communication unit of S-GW and/or a communication unit of PCRF and/or a communication unit of the content server. For example, the communication unit 410 receives a video request message from UE and a video response message from a content server, and also receives a user policy request message and the response message from the PCRF.

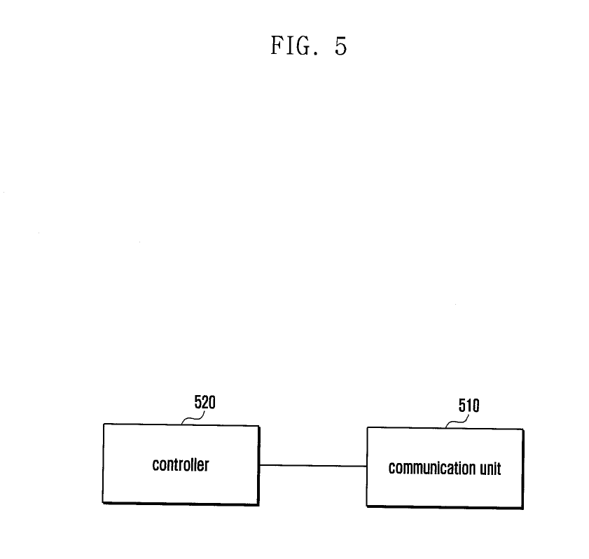

FIG. 5 is a block diagram of an eNB according to an embodiment of the present invention.

Referring to FIG. 5, the controller 520 controls an eNB to perform operations of one of the embodiments described above. For example, the controller 520: receives the video packet in which VTIC is recorded from the P-GW; determines whether it will apply congestion mitigation of video traffic to the received video packet, using VTIC; adjusts the transmission rate of the video packet; and transmits the video packet to the UE.

The communication unit 510 performs transmission/reception of signals according to operations of one of the embodiments described above. For example, communication unit 510 transmits/receives data to/from: a communication unit of UE and/or a communication unit of an S-GW and/or a communication unit of a P-GW and/or a communication unit of a content server. For example, the communication unit 510 receives the video packet in which VTIC is recorded from a communication unit of P-GW and transmits the video packet to the UE at an adjusted transmission rate.

The embodiments of the present invention described in the description and drawings are merely provided to assist in a comprehensive understanding of the invention and are not suggestive of limitation. Although embodiments of the invention have been described in detail above, it should be understood that many variations and modifications of the basic inventive concept herein described, which may be apparent to those skilled in the art, will still fall within the spirit and scope of the embodiments of the invention as defined in the appended claims.

The terms and words used in the description are not limited to the bibliographical meanings, but, are merely used by the inventor to enable a clear and consistent understanding of the present disclosure. Accordingly, it should be apparent to those skilled in the art that the description of various embodiments of the present disclosure is provided for illustration purpose only and not for the purpose of limiting the present disclosure as defined by the appended claims and their equivalents.

1. A communication method of a Packet data network-Gateway (P-GW) in a mobile communication system comprising:
identifying video information, using a video request message of a terminal and a video response message of a content server;
receiving a video packet from the content server;
detecting a buffer status of the terminal, using the video packet;
recording, in a header of the video packet, Video Traffic Information for Congestion control (VTIC) containing information regarding the buffer status of the terminal and the video information; and
transmitting the video packet in which the VTIC is recorded to a base station (eNB).

2. The method of claim 1, wherein identifying video information comprises:
requesting user policy information from a Policy and Charging Rules Function (PCRF); and
receiving user policy information from the PCRF.

3. The method of claim 1, wherein identifying video information comprises:
receiving an HTTP request message from the terminal;
identifying a video request message using the HTTP request message;
receiving an HTTP response message from the content server; and
identifying video content information using the HTTP response message.

4. The method of claim 1, wherein identifying video information comprises:
receiving a metadata file request message from the terminal;
identifying a video request message, using the metadata file request message;
receiving a metadata file from the content server; and
identifying video content information, using the metadata file.

5. The method of claim 1, wherein the VTIC comprises at least one of the following:
user rating information, service provider information, a video transmission type, a buffer status of the terminal, a Quality of Experience (QoE) efficiency level, or an adaptation method.

6. The method of claim 5, wherein, when the video transmission type is an HTTP Adaptive Streaming (HAS) scheme, the QoE efficiency level is calculated using a transmission rate of video currently transmitted in HAS, a transmission rate of video lower in quality by one level than that currently transmitted in HAS, and QoE information according to the transmission rate.

7. A communication method of a base station (eNB) in a mobile communication system comprising:
receiving a video packet in which Video Traffic Information for Congestion control (VTIC) is recorded from a Packet data network-Gateway (P-GW);
determining whether to apply congestion mitigation of video traffic to the received video packet, using the VTIC; and
adjusting a transmission rate of the video packet, and transmitting the video packet to a terminal at the adjusted transmission rate,
wherein the VTIC contains information regarding a buffer status of the terminal and video information that the P-GW has identified using a video request message of the terminal and a video response message of a content server.

8. The method of claim 7, wherein transmitting the video packet to a terminal comprises:
transmitting, to the P-GW, a transmission rate adjustment request message for a video packet to which congestion mitigation is applied;
receiving a video packet whose transmission rate is adjusted from the P-GW; and
transmitting, to the terminal, the video packet whose transmission rate is adjusted.

9. The method of claim 7, wherein the VTIC comprises at least one of the following:
user rating information, service provider information, a video transmission type, a buffer status of the terminal, a Quality of Experience (QoE) efficiency level, or an adaptation method.

10. The method of claim 9, wherein, when the video transmission type is an HTTP Adaptive Streaming (HAS) scheme, the QoE efficiency level is calculated using a transmission rate of video currently transmitted in HAS, a transmission rate of video lower in quality by one level than that currently transmitted in HAS, and QoE information according to the transmission rate.

11. A Packet data network-Gateway (P-GW) of a mobile communication system comprising:
a communication unit configured to communicate with other network entities; and
a controller configured to:
identify video information, using a video request message of a terminal and a video response message of a content server;
receive a video packet from the content server;
detect a buffer status of the terminal, using the video packet;
record, in a header of the video packet, Video Traffic Information for Congestion control (VTIC) containing information regarding the buffer status of the terminal and the video information; and
transmit the video packet in which the VTIC is recorded to a base station.

12. The P-GW of claim 11, wherein the controller is configured to request user policy information from a Policy and Charging Rules Function (PCRF) and receive user policy information from the PCRF.

13. The P-GW of claim 11, wherein the controller is configured to:
receive an HTTP request message from the terminal;
identify a video request message using the HTTP request message;
receive an HTTP response message from the content server; and
identify video content information using the HTTP response message.

14. The P-GW of claim 11, wherein the controller is configured to:
receive a metadata file request message from the terminal;
identify a video request message, using the metadata file request message;
receive a metadata file from the content server; and
identify video content information, using the metadata file.

15. The P-GW of claim 11, wherein the VTIC comprises at least one of the following:
user rating information, service provider information, a video transmission type, a buffer status of the terminal, a Quality of Experience (QoE) efficiency level, or an adaptation method.

16. The P-GW of claim 15, wherein, when the video transmission type is an HTTP Adaptive Streaming (HAS) scheme, the QoE efficiency level is calculated using a transmission rate of video currently transmitted in HAS, a transmission rate of video lower in quality by one level than that currently transmitted in HAS, and QoE information according to the transmission rate.

17. A base station of a mobile communication system comprising:
a communication unit configured to communicate with other network entities; and
a controller configured to;
receive a video packet in which Video Traffic Information for Congestion control (VTIC) is recorded from a P-GW;
determine whether to apply congestion mitigation of video traffic to the received video packet, using the VTIC;
adjust a transmission rate of the video packet; and
transmit the video packet to a terminal at the adjusted transmission rate,
wherein the VTIC contains information regarding a buffer status of the terminal and video information that the P-GW has identified using a video request message of the terminal and a video response message of a content server.

18. The base station of claim 17, wherein the controller is configured to:
transmit, to the P-GW, a transmission rate adjustment request message for a video packet to which congestion mitigation is applied;
receive a video packet whose transmission rate is adjusted from the P-GW; and
transmit, to the terminal, the video packet whose transmission rate is adjusted.

19. The base station of claim 17, wherein the VTIC comprises at least one of the following:
user rating information, service provider information, a video transmission type, a buffer status of the terminal, a Quality of Experience (QoE) efficiency level, or an adaptation method.

20. The base station of claim 19, wherein, when the video transmission type is an HTTP Adaptive Streaming (HAS) scheme, the QoE efficiency level is calculated using a transmission rate of video currently transmitted in HAS, a transmission rate of video lower in quality by one level than that currently transmitted in HAS, and QoE information according to the transmission rate.
